(19) United States
(12) Patent Application Publication
(10) Pub. No.: US 2023/0334569 A1
(43) Pub. Date: Oct. 19, 2023

(54) SYSTEM FOR MANAGING THE CONVERSION OF QUANTITIES OF NON-FUNGIBLE TOKENS

(71) Applicant: The Smuggleverse LLC, Henderson, NV (US)

(72) Inventor: Will MAURER, Sherman Oaks, CA (US)

(73) Assignee: The Smuggleverse LLC, Henderson, NV (US)

(21) Appl. No.: 18/301,722

(22) Filed: Apr. 17, 2023

Related U.S. Application Data
(60) Provisional application No. 63/332,240, filed on Apr. 18, 2022.
(60) Provisional application No. 63/346,749, filed on May 27, 2022.

(51) Int. Cl. G06Q 40/04; G06Q 20/36

(52) U.S. Cl. CPC G06Q 40/04; G06Q 20/36; G06Q 2220/165

(57) ABSTRACT

In general, one aspect disclosed features a process comprising: providing, a first electronic user interface comprising (i) a first presentation portion for displaying an image associated with a non-fungible token (NFT) and a value associated with the NFT and (ii) a first interactive element operable by a user to generate a request to cut the NFT into multiple constituent NFTs; receiving the request to cut the NFT responsive to user operation of the first interactive element; responsive to receiving the request to cut the NFT, providing a second electronic user interface comprising (i) at least one second interactive element operable by the user to select a respective value from a set of predetermined values for each of the constituent NFTs and (ii) a third interactive element operable by the user to generate a command to cut the NFT according to the selected values for each of the constituent NFTs.

### CROSS REFERENCE TO RELATED APPLICATIONS

The present application claims priority to U.S. Provisional Patent Application No. 63/332,240, filed Apr. 18, 2022, entitled “SYSTEM FOR MANAGING THE DIVISION OF NON-FUNGIBLE TOKENS INTO CONSTITUENT NON-FUNGIBLE TOKENS” and U.S. Provisional Patent Application No. 63/346,749, filed May 27, 2022, entitled “SYSTEM FOR MANAGING THE DIVISION AND COMBINATION OF NON-FUNGIBLE TOKENS”, the disclosures thereof are incorporated by reference herein in their entirety.

### DESCRIPTION OF RELATED ART

The disclosed technology relates generally to non-interchangeable cryptographic assets, and more particularly some embodiments relate to managing such assets.

### SUMMARY

In general, one aspect disclosed features a system for managing the conversion of non-fungible tokens (NFTs) into constituent NFTs, the system comprising: a hardware processor; and a non-transitory machine-readable storage medium encoded with instructions executable by the hardware processor to perform operations comprising: providing, over a network to a client device of a user, a first electronic user interface comprising (i) a first presentation portion for displaying an image associated with an NFT and a weight value associated with the NFT and (ii) a first interactive element operable by a user to generate a request to cut the NFT into multiple constituent NFTs; receiving the request to cut the NFT responsive to user operation of the first interactive element; responsive to receiving the request to cut the NFT, providing, over the network to the client device, a second electronic user interface comprising (i) at least one second interactive element operable by the user to select a respective weight from a set of predetermined weights for each of the constituent NFTs and (ii) a third interactive element operable by the user to generate a command to cut the NFT according to the selected weights for each of the constituent NFTs; receiving the command to cut the NFT responsive to user operation of the third interactive element; responsive to receiving the command to cut the NFT, verifying the sum of the selected weights of the constituent NFTs equals the weight value of the NFT; and responsive to verifying the sum of the selected weights of the constituent NFTs equals the weight value of the NFT, burning the NFT and minting the constituent NFTs according to the selected weights of the constituent NFTs.

Embodiments of the system may include one or more of the following features. In some embodiments, responsive to receiving the request to cut the NFT, and prior to providing the second electronic user interface, the operations further comprise: determining whether a digital wallet of the user is connected to the system; and responsive to determining the digital wallet of the user is not connected to the system, transmitting, over the network to the client device, an electronic request to connect the digital wallet of the user to the system. In some embodiments, responsive to receiving the request to cut the NFT, and prior to providing the second electronic user interface, the operations further comprise at least one of: determining whether the user owns the NFT, and responsive to determining the user does not own the NFT, transmitting, over the network to the client device, an electronic message denying the request to cut the NFT; determining whether the NFT is on sale, and responsive to determining the NFT is on sale, transmitting, over the network to the client device, an electronic request to take the NFT off sale; determining whether the NFT is on auction, and responsive to determining the NFT is on auction, transmitting, over the network to the client device, an electronic request to take the NFT off auction; or verifying a value of the NFT. In some embodiments, the operations further comprise: prior to burning the NFT and minting the constituent NFTs, identifying a further NFT to be used to pay a cutting fee.

In some embodiments, the operations further comprise: receiving, over the network from the client device, a request from the user to consume one of the constituent NFTs in a metaverse; responsive to receiving the request from the user to consume the one of the constituent NFTs in the metaverse, generating a 3D object in the metaverse based on the image, and allowing the user to control an avatar of the user to consume the 3D object in the metaverse; and responsive to the user controlling the avatar of the user to consume the 3D object in the metaverse, burning the one of the constituent NFTs. In some embodiments, minting the constituent NFTs comprises: minting a seed NFT for any constituent NFT minted above a predetermined weight; and when the user owns virtual land in a metaverse, allowing the user to create a new NFT based on the seed NFT.

In general, one aspect disclosed features a system for managing the combination of non-fungible tokens (NFTs), the system comprising: a hardware processor; and a non-transitory machine-readable storage medium encoded with instructions executable by the hardware processor to perform operations comprising: providing, over a network to a client device of a user, a first electronic user interface comprising a first interactive element operable by a user to generate a request to stack multiple NFTs into a single NFT; receiving the request to stack multiple NFTs into a single NFT responsive to user operation of the first interactive element; responsive to receiving the request to stack multiple NFTs into a single NFT, providing, over the network to the client device of the user, a second electronic user interface comprising (i) a first presentation portion for displaying multiple constituent NFTs and remaining weights associated with each of the constituent NFTs, (ii) second interactive elements operable by a user to choose selected weights for two or more of the constituent NFTs, and (iii) a third interactive element operable by a user to generate a command to stack the selected weights of the two or more of the constituent NFTs into a single composite NFT; receiving the command to stack the selected weights of the two or more of the constituent NFTs into a single composite NFT responsive to user operation of the third interactive element; responsive to receiving the command to stack the selected weights of the two or more of the constituent NFTs into a single composite NFT, verifying the sum of the selected weights of the constituent NFTs equals an allowed weight from a set of predetermined weights; and responsive to verifying the sum of the selected weights of the constituent NFTs equals one of the allowed weights, stacking the constituent NFTs by burning the constituent NFTs and minting the single composite NFT according to the selected weight value of the constituent NFTs.

Embodiments of the system may include one or more of the following features. In some embodiments, responsive to receiving the command to stack the selected weights of the two or more of the constituent NFTs into a single composite NFT, and prior to stacking the constituent NFTs, the operations further comprise: determining whether a digital wallet of the user is connected to the system; and responsive to determining the digital wallet of the user is not connected to the system, transmitting, over the network to the client device, an electronic request to connect the digital wallet of the user to the system. In some embodiments, responsive to receiving the command to stack the selected weights of the two or more of the constituent NFTs into a single composite NFT, and prior to stacking the constituent NFTs, the operations further comprise at least one of: determining whether the user owns the constituent NFTs, and responsive to determining the user does not own the constituent NFTs, transmitting, over the network to the client device, an electronic message denying the command to stack the selected weights of the two or more of the constituent NFTs into a single composite NFT; determining whether the constituent NFTs are on sale, and responsive to determining the constituent NFTs are on sale, transmitting, over the network to the client device, an electronic request to take the constituent NFTs off sale; determining whether the constituent NFTs are on auction, and responsive to determining the constituent NFTs are on auction, transmitting, over the network to the client device, an electronic request to take the constituent NFTs off auction; or verifying values of the constituent NFTs.

In some embodiments, the operations further comprise: prior to stacking the constituent NFTs, identifying a further NFT to be used to pay a stacking fee. In some embodiments, the operations further comprise: receiving, over the network from the client device, a request from the user to consume the single composite NFT in a metaverse; responsive to receiving the request from the user to consume the single composite NFT in the metaverse, generating a 3D object in the metaverse based on the single composite NFT, and allowing the user to control an avatar of the user to consume the 3D object in the metaverse; and responsive to the user controlling the avatar of the user to consume the 3D object in the metaverse, burning the single composite NFT.

In general, one aspect disclosed features a non-transitory machine-readable storage medium encoded with instructions executable by a hardware processor to perform operations comprising: providing, over a network to a client device of a user, a first electronic user interface comprising (i) a first presentation portion for displaying an image associated with a non-fungible token (NFT) and a weight value associated with the NFT and (ii) a first interactive element operable by a user to generate a request to cut the NFT into multiple constituent NFTs; receiving the request to cut the NFT responsive to user operation of the first interactive element; responsive to receiving the request to cut the NFT, providing, over the network to the client device, a second electronic user interface comprising (i) at least one second interactive element operable by the user to select a respective weight from a set of predetermined weights for each of the constituent NFTs and (ii) a third interactive element operable by the user to generate a command to cut the NFT according to the selected weights for each of the constituent NFTs; receiving the command to cut the NFT responsive to user operation of the third interactive element; responsive to receiving the command to cut the NFT, verifying the sum of the selected weights of the constituent NFTs equals the weight value of the NFT; and responsive to verifying the sum of the selected weights of the constituent NFTs equals the weight value of the NFT, burning the NFT and minting the constituent NFTs according to the selected weights of the constituent NFTs.

Embodiments of the non-transitory machine-readable storage medium may include one or more of the following features. In some embodiments, responsive to receiving the request to cut the NFT, and prior to providing the second electronic user interface, the operations further comprise: determining whether a digital wallet of the user is connected; and responsive to determining the digital wallet of the user is not connected, transmitting, over the network to the client device, an electronic request to connect the digital wallet of the user. In some embodiments, responsive to receiving the request to cut the NFT, and prior to providing the second electronic user interface, the operations further comprise at least one of: determining whether the user owns the NFT, and responsive to determining the user does not own the NFT, transmitting, over the network to the client device, an electronic message denying the request to cut the NFT; determining whether the NFT is on sale, and responsive to determining the NFT is on sale, transmitting, over the network to the client device, an electronic request to take the NFT off sale; determining whether the NFT is on auction, and responsive to determining the NFT is on auction, transmitting, over the network to the client device, an electronic request to take the NFT off auction; or verifying a value of the NFT.

In some embodiments, the operations further comprise: prior to burning the NFT and minting the constituent NFTs, identifying a further NFT to be used to pay a cutting fee. In some embodiments, the operations further comprise: receiving, over the network from the client device, a request from the user to consume one of the constituent NFTs in a metaverse; responsive to receiving the request from the user to consume the one of the constituent NFTs in the metaverse, generating a 3D object in the metaverse based on the image, and allowing the user to control an avatar of the user to consume the 3D object in the metaverse; and responsive to the user controlling the avatar of the user to consume the 3D object in the metaverse, burning the one of the constituent NFTs. In some embodiments, minting the constituent NFTs comprises: minting a seed NFT for any constituent NFT minted above a predetermined weight; and when the user owns virtual land in a metaverse, allowing the user to create a new NFT based on the seed NFT.

In general, one aspect disclosed features a non-transitory machine-readable storage medium encoded with instructions executable by a hardware processor to perform operations comprising: providing, over a network to a client device of a user, a first electronic user interface comprising a first interactive element operable by a user to generate a request to stack multiple non-fungible tokens (NFTs) into a single NFT; receiving the request to stack multiple NFTs into a single NFT responsive to user operation of the first interactive element; responsive to receiving the request to stack multiple NFTs into a single NFT, providing, over the network to the client device of the user, a second electronic user interface comprising (i) a first presentation portion for displaying multiple constituent NFTs and remaining weights associated with each of the constituent NFTs, (ii) second interactive elements operable by a user to choose selected weights for two or more of the constituent NFTs, and (iii) a third interactive element operable by a user to generate a command to stack the selected weights of the two or more of the constituent NFTs into a single composite NFT; receiving the command to stack the selected weights of the two or more of the constituent NFTs into a single composite NFT responsive to user operation of the third interactive element; responsive to receiving the command to stack the selected weights of the two or more of the constituent NFTs into a single composite NFT, verifying the sum of the selected weights of the constituent NFTs equals an allowed weight from a set of predetermined weights; and responsive to verifying the sum of the selected weights of the constituent NFTs equals one of the allowed weights, stacking the constituent NFTs by burning the constituent NFTs and minting the single composite NFT according to the selected weight value of the constituent NFTs.

Embodiments of the non-transitory machine-readable storage medium may include one or more of the following features. In some embodiments, responsive to receiving the command to stack the selected weights of the two or more of the constituent NFTs into a single composite NFT, and prior to stacking the constituent NFTs, the operations further comprise: determining whether a digital wallet of the user is connected; and responsive to determining the digital wallet of the user is not connected, transmitting, over the network to the client device, an electronic request to connect the digital wallet of the user. In some embodiments, responsive to receiving the command to stack the selected weights of the two or more of the constituent non-fungible tokens (NFTs) into a single composite NFT, and prior to stacking the constituent NFTs, the operations further comprise at least one of: determining whether the user owns the constituent NFTs, and responsive to determining the user does not own the constituent NFTs, transmitting, over the network to the client device, an electronic message denying the command to stack the selected weights of the two or more of the constituent NFTs into a single composite NFT; determining whether the constituent NFTs are on sale, and responsive to determining the constituent NFTs are on sale, transmitting, over the network to the client device, an electronic request to take the constituent NFTs off sale; determining whether the constituent NFTs are on auction, and responsive to determining the constituent NFTs are on auction, transmitting, over the network to the client device, an electronic request to take the constituent NFTs off auction; or verifying values of the constituent NFTs.

In some embodiments, the operations further comprise: prior to stacking the constituent NFTs, identifying a further NFT to be used to pay a stacking fee. In some embodiments, the operations further comprise: receiving, over the network from the client device, a request from the user to consume the single composite NFT in a metaverse; responsive to receiving the request from the user to consume the single composite NFT in the metaverse, generating a 3D object in the metaverse based on the single composite NFT, and allowing the user to control an avatar of the user to consume the 3D object in the metaverse; and responsive to the user controlling the avatar of the user to consume the 3D object in the metaverse, burning the single composite NFT.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of a NFT system according to some embodiments of the disclosed technologies.

FIG. 2 illustrates an example of a node in a blockchain network according to some embodiments of the disclosed technologies.

FIG. 3 depicts a corresponding quantity conversion calculator.

FIG. 4 is a flowchart illustrating a process for NFT cutting and management according to some embodiments of the disclosed technologies.

FIG. 5 illustrates an example user interface according to some embodiments of the disclosed technologies.

FIG. 6 illustrates an example user interface according to some embodiments of the disclosed technologies.

FIG. 7 is a flowchart illustrating a process for NFT stacking and management according to some embodiments of the disclosed technologies.

FIG. 8 illustrates an example user interface according to some embodiments of the disclosed technologies.

FIG. 9 illustrates an example user interface according to some embodiments of the disclosed technologies.

FIG. 10 depicts a block diagram of an example computer system in which embodiments described herein may be implemented.

FIGS. 11A,B illustrate code for a non-limiting example of one way to implement a system for cutting NFTs according to some embodiments of the disclosed technology.

FIGS. 12A,B,C illustrate code for a non-limiting example of one way to implement a system for stacking NFTs according to some embodiments of the disclosed technology.

The figures are not exhaustive and do not limit the present disclosure to the precise form disclosed.

### DETAILED DESCRIPTION

A non-fungible token (NFT) is a cryptographic token ownership of which is stored on a blockchain and which may represent rights to a digital asset (and/or a physical asset or entitlement). Each NFT is uniquely identifiable, for example by bearing unique identification codes and metadata that distinguish NFTs from each other. NFTs differ from most cryptocurrencies, which are fungible, for example such as Bitcoin, Ethereum, and Hex. NFTs are increasingly popular for sale and trade. Much of the current market for NFTs involves collectibles, such as digital artwork, sports cards, and rarities. Currently, an NFT is not divisible. That is, one cannot separate an NFT into smaller units to facilitate sale and trade in smaller quantities. Similarly, multiple NFTs currently cannot be combined into a single NFT. Often the digital asset comprises a 2D image, although other digital objects are envisioned herein.

Some embodiments of the disclosure provide technologies for effectively “cutting” an NFT into smaller units, referred to herein as “constituent NFTs”. As part of the process, the cut NFT is burned and two or more NFTs representing smaller units are minted in its place.

Some embodiments of the disclosure provide technologies for effectively combining or “stacking” multiple NFTs, referred to herein as “constituent NFTs”, into a single NFT, referred to herein as “composite NFT”. As part of the process, the constituent NFTs are burned and the composite NFTs is minted in their place.

These technologies provide custom user interfaces that allow users to view images and metadata for an NFT, and for controlling the cutting and stacking process, for example by selecting particular ways of cutting or stacking the NFT. These technologies may also provide various verification mechanisms, for example to ensure that the sum of the values of the constituent NFTs equals the value of the NFT being cut. Other verification mechanisms may verify ownership of the NFT, whether the NFT is on sale or auction, and the value of the NFT. As used herein, the term “value” is not a price value, but is rather a metadata value that is assigned to each NFT in a collection.

The techniques described herein may be used in a variety of practical applications including for example a game. For example, one game mechanic may involve the game platform creating one or more versions of a digital object (e.g., strains of a digital cannabis or versions of other digital objects), where a first NFT is issued for a first version of a digital object (e.g., a first quantity of a strain of a digital cannabis) and a user acquires that NFT for a first amount of value. As part of the game mechanic, users may employ strategies to decide when and at what levels to “cut” the first NFT to multiple NFTs each representing smaller quantities of the strain of digital cannabis in an effort to maximize a virtual profit, taking into account that there may be non-linear relationship between the price of 1 unit compared to a fraction of the unit. Given a virtual economy for the various quantities of digital cannabis represented by the different NFTs, the user must exercise skill in deciding when and how much to cut to maximize virtual profits to succeed in the game. For example, as the quantities of a particular NFT diminish due to consumption of that NFT, the value of each unit of that NFT may increase. In some embodiments, a fee is required to cut or stack an NFT. In such embodiments, a user's strategy may consider the number of times to cut, as well as the selection of weights of the resulting constituent NFTs. In other embodiments, no fee is required to cut or stack an NFT.

In the described embodiments, NFT values may be expressed in terms of “weight”. In other embodiments, NFT values may be expressed in other ways. By way of non-limiting examples, NFT values may be expressed in terms of rarity, power, rating, or other measure or value.

Some embodiments may link the NFTs to activities of the owner in one or more metaverses or other online platforms. For example, embodiments may allow an owner of an NFT to generate a 3D object based on the NFT. The 3D object may represent a digital object with which an avatar representation associated with the user may interact. For example, the avatar may appear to be interacting with a digital joint by appearing to smoke it. According to another aspect of the invention, the 3D digital object associated with an NFT may have a functional use and be a consumable whereby once it is used for its intended function, it is deemed consumed. Consuming the object may consume the NFT as well, for example extinguishing the NFT by rendering it valueless.

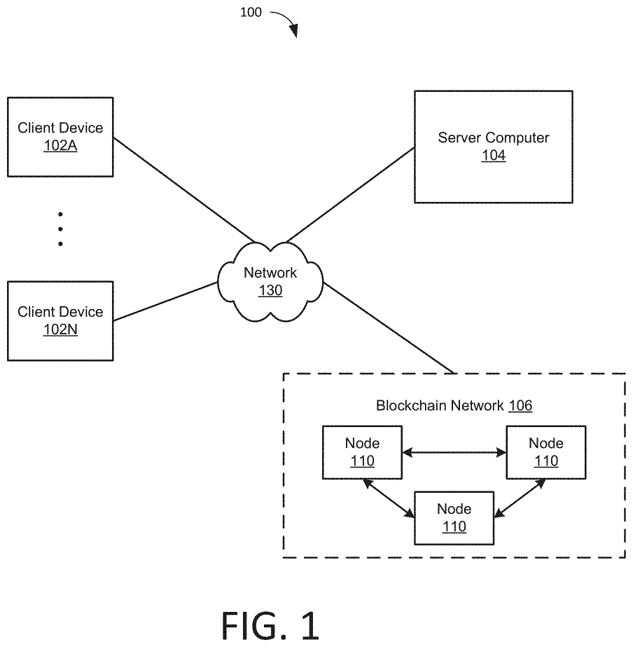

FIG. 1 illustrates an example of a NFT system 100 according to some embodiments of the disclosed technologies. Users of the NFT system 100 may employ client devices 102A-N to interact with the system 100. The system 100 may include one or more server computers and a blockchain network 106. The client devices 102, server computer 104, and blockchain network 106 may communicate over one or more networks 130.

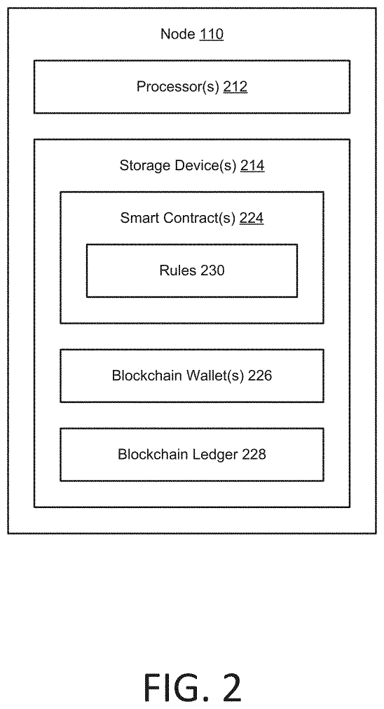

FIG. 2 illustrates an example of a node 110 in a blockchain network 106 according to some embodiments of the disclosed technologies. In various implementations, each node 110 may include one or more processors 212 programmed by computer program instructions stored at one or more storage devices 214. The storage devices 214 may store a smart contract that executes one or more rules 230. Each node 110 may store one or more blockchain wallets 226 for exchanging cryptocurrencies. Each node 110 may store a blockchain ledger 228. The blockchain ledger 228 is a decentralized ledger, a copy of at least a portion or all of which is stored at each node 110. The blockchain ledger 228 may store transactions described herein. Such transactions may include the sales and trades of NFTs, and/or other transactions.

In this disclosure, the NFTs are digital cannabis. An example metaverse is referred to herein as the “smuggleverse”, and the users are referred to as “smugglers”. However, the disclosed technologies may be applied to other NFTs and multiverses. Certain other terms used herein are defined below.

STRAIN: a variety of digital cannabis. Users may purchase a limited supply of each digital strain in the form of an NFT, and stack their profits by flipping their stash throughout the metaverse. Each strain may consist for example of 20 pounds across 9 different quantities ranging from a KILO to a JOINT.

QUANTITIES: NFT'S may be smuggled (e.g., bought, sold, or traded) in the form of a weight, for example, a KILO, POUND, HALF-POUND, QUARTER-POUND, OUNCE, HALF-OUNCE, QUARTER-OUNCE, EIGHTH-OUNCE & JOINT. As used herein, the term “weight” is a metadata value.

SEEDS: NFTs having weights above a predetermined threshold may be minted with SEED NFTs that can be used to create hybrid strains once virtual land is released in the SMUGGLEVERSE. For example, any NFT minted with a weight of a quarter-pound or more may be minted with such a seed NFT. There may be a maximum number of seeds per strain.

CUT: The disclosed technology allows users to CUT a single NFT into multiple NFT'S, which may be of equal weight value. This custom feature provides a unique gamification element to each user's individual strategy. Once an NFT has been CUT it may be deleted from the total number of NFTs in that particular quantity, and new constituent NFTs get minted.

CUT and BURN: A “CUT” reduces the total number of NFT'S in a particular quantity, while a “BURN” reduces the total weight of the strain based on the weight of the NFT that is being burned.

STACK: The disclosed technology allows users to STACK multiple NFTs to create a new single NFT, which may be of equal weight value. This custom feature provides a unique gamification element to each user's individual strategy. Once NFTs has been STACKED they may be deleted from the total number of NFTs in that particular quantity, and a new composite NFT gets minted.

STACK and BURN: A “STACK” reduces the total number of NFT'S in a particular quantity, while a “BURN” reduces the total weight of the strain based on the weight of the NFTs that are being burned.

SCARCITY: Each strain may have a limited number of NFT'S per quantity—for example, the KILO NFT may be a 1-of-1. CUTTING and BURNING continuously affect the scarcity of each quantity, as well as the total supply of each strain, which adds a gamification element to user strategy to maximize profits.

MUSIC: SMUGGLEVERSE MUSIC GROUP (SMG) is a virtual label created to produce collabs between Avatars in the Metaverse and the biggest stars in the real-world. A limited supply of NFTs representing new music tracks are released with each strain and provide unprecedented access and utility for its holders, including the ability to use a SMUGGLEVERSE MUSIC NFT as a fee to unlock the cutting and stacking functionality.

UTILITY: NFT'S are the currency of the SMUGGLEVERSE, and the smugglers are rewarded for their service. The disclosed CUTTING technology can turn a single NFT into two or more new NFTs, and the STACKING technology can turn two or more NFTs into a single NFT. As the SMUGGLEVERSE continues to grow and evolve, Smugglers will get priority access to virtual events and concerts, exclusive giveaways, access to new strains, music and skins, future drops, virtual land sales, and much more.

BURN PARTY: Users may host virtual burn sessions and get HIGH with SMUGGLEBOT while increasing their Kingpin status and adding value to the strain by reducing the total weight and supply of that strain.

SMUGGLEVERSE MUSIC GROUP: SMG is a full-service music production company consisting of multi-platinum Producers, Songwriters, and Recording Artists. From celebrity collabs and virtual performances to burn parties, music videos and a talented stable of Avatar artists—SMUGGLEVERSE MUSIC GROUP is known for producing the hottest music and experiences in the Metaverse.

An admin may assign a weight value to each NFT in a collection. For example, an NFT collection may include 9 different rarities each described as a “QUANTITY”, which is also referred to as “WEIGHT”, and each QUANTITY is assigned a WEIGHT VALUE, for example as shown in Table 1.

TABLE 1

| QUANTITY | WEIGHT VALUE |
|---|---|
| KILO | 2.203125 |
| POUND | 1 |
| HALF-POUND | 0.5 |
| QUARTER-POUND | 0.25 |
| OUNCE | 0.0625 |
| HALF-OUNCE | 0.03125 |
| QUARTER-OUNCE | 0.015625 |
| EIGHTH-OUNCE | 0.0078125 |
| JOINT | 0.00390625 |

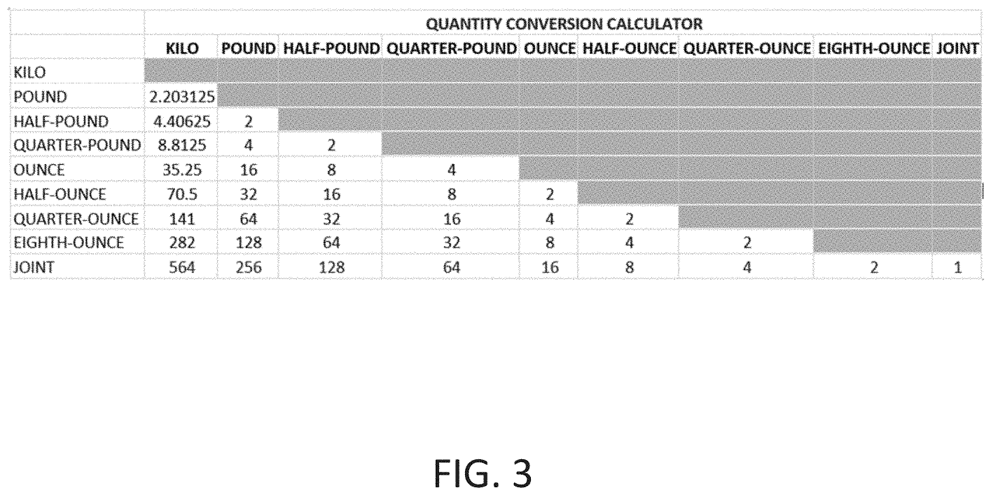

FIG. 3 depicts a corresponding quantity conversion calculator.

The SmuggleVerse may receive a royalty on all secondary sales of NFTs, for example 10%. In some embodiments, a maximum number of unique strains will be released per year (e.g., 6 strains per year), with a particular estimated pricing increase (e.g., 20%) for each new strain to lock in additional value for early holders.

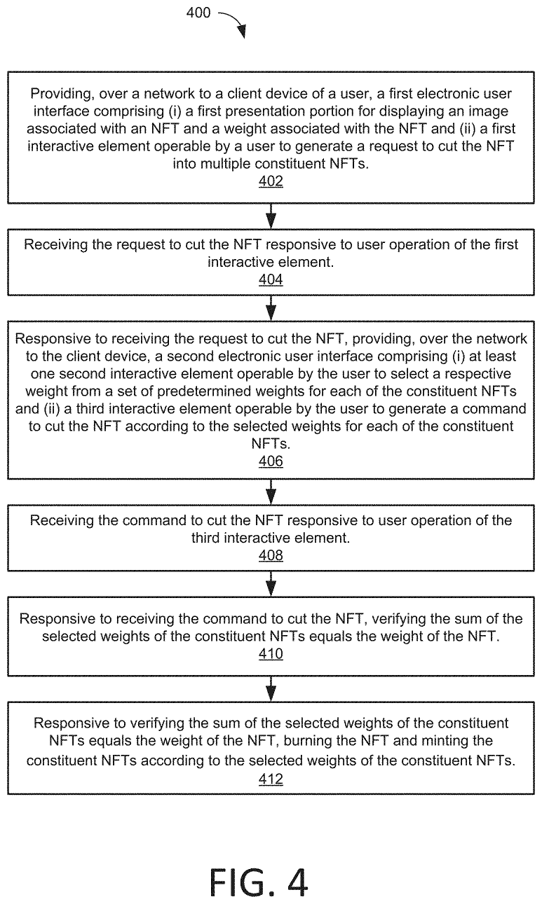

FIG. 4 is a flowchart illustrating a process 400 for NFT cutting and management according to some embodiments of the disclosed technologies. The elements of the process 400 are presented in one arrangement. However, it should be understood that one or more elements of the process may be performed in a different order, in parallel, omitted entirely, and the like. Furthermore, the process 400 may include other elements in addition to those presented. For example, the process 400 may include error-handling functions if exceptions occur, and the like. The process 400 may be executed, for example, by the NFT system 100 of FIGS. 1 and 2.

Referring again to FIG. 4, the process 400 may include providing, over a network to a client device of a user, a first electronic user interface comprising (i) a first presentation portion for displaying an image associated with an NFT and a weight value associated with the NFT and (ii) a first interactive element operable by a user to generate a request to cut the NFT into multiple constituent NFTs, at 402. The system may determine whether a digital wallet of the user is connected to the system. Responsive to determining the digital wallet of the user is not connected to the system, the system may transmit, over the network to the client device, an electronic request to connect the digital wallet of the user to the system.

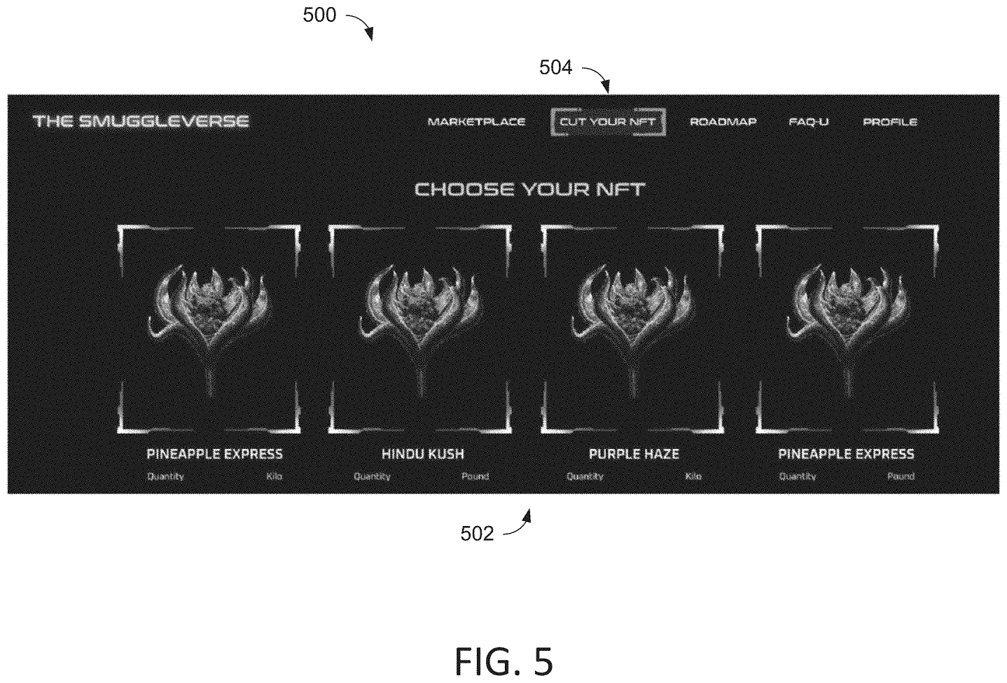

FIG. 5 illustrates an example user interface 500 according to some embodiments of the disclosed technologies. The user interface 500 may display all NFTs owned by the user. This list may be fetched by using an API call. Referring to FIG. 5, the user interface 500 includes a presentation portion, at 502, that displays images associated with NFTs “Pineapple Express”, “Hindu Kush”, and “Purple Haze”, as well as a weight associated with each NFT (e.g., kilo, pound). The user interface also includes interactive elements, at 504, operable by a user to generate a request to cut a selected NFT into multiple constituent NFTs.

The user may select a single NFT to be cut. Referring again to FIG. 4, the process 400 may include receiving the request to cut the NFT responsive to user operation of the first interactive element, at 404. If a user tries to select a joint, seed or music NFT, a message will be displayed “You can only cut NFTs that have a weight value greater than a joint”.

From the UI a smart contract function may be invoked to verify that the user owns the selected NFT (Contract function—balanceOf (NFT tokenId, user_connected_wallet_address)). If it is not owned by the user, the contract will return false. If it is owned by user, the contract will return true. Responsive to determining the user does not own the NFT, the system may transmit, over the network to the client device, an electronic message denying the request to cut the NFT.

From the UI, a smart contract function may be invoked to verify the NFTs weight value. From the UI, a smart contract function will be invoked to check whether the NFT is on sale or not (Contract function—isOnSale (NFT tokenId)). If it is on sale, the contract will return a true value. If it is not on sale, the contract will return a false value. Responsive to determining the NFT is on sale, the system may transmit, over the network to the client device, an electronic request to take the NFT off sale.

If the NFT is not on sale, another smart contract function may be invoked from UI to check whether the NFT is on auction or not (Contract function—isOnAuction(NFT tokenId)). If it is on auction, the contract will return a true value. If it is not in auction, the contract will return a false value. Responsive to determining the NFT is on auction, the system may transmit, over the network to the client device, an electronic request to take the NFT off auction.

The process 400 may include, responsive to receiving the request to cut the NFT, providing, over the network to the client device, a second electronic user interface comprising (i) at least one second interactive element operable by the user to select a respective weight from a set of predetermined weights for each of the constituent NFTs and (ii) a third interactive element operable by the user to generate a command to cut the NFT according to the selected weights for each of the constituent NFTs, at 406. The predetermined value of each weight may be, for example, as listed in Table 1.

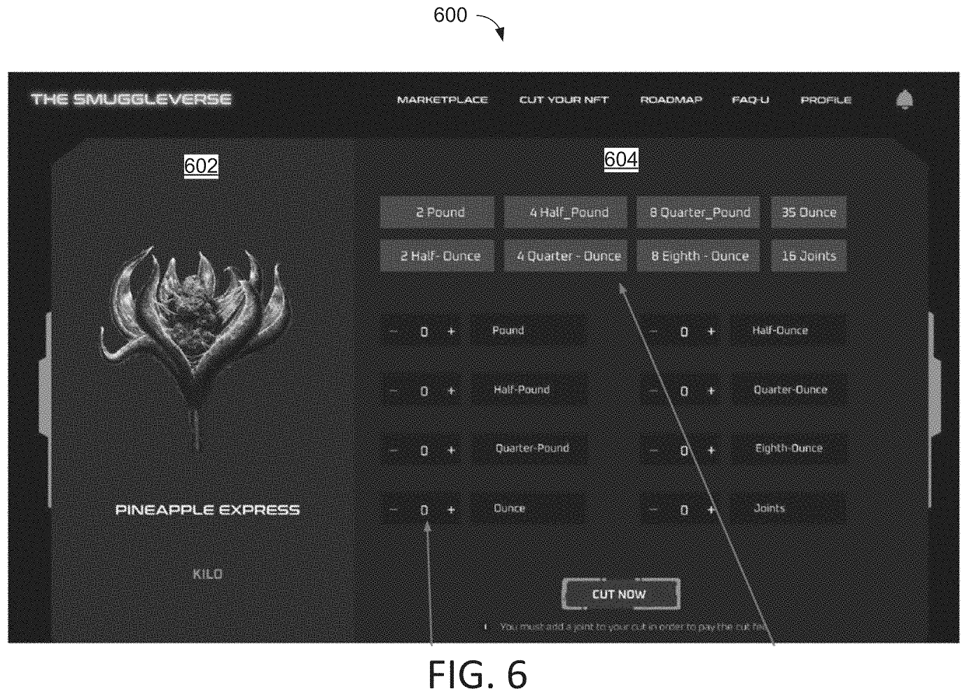

FIG. 6 illustrates an example user interface 600 according to some embodiments of the disclosed technologies. Referring to FIG. 6, the user interface 600 includes a presentation portion, at 602, that displays an image associated with an NFT “Pineapple Express” and a weight associated with the NFT (KILO). The user interface also includes interactive elements, at 604, operable by a user to generate a command to cut the NFT into multiple constituent NFTs. Referring again to FIG. 4, the process 400 may include receiving the command to cut the NFT responsive to user operation of the third interactive element, at 408.

The value of each new constituent NFT selected by a user may be auto-calculated and added to a cart. The process 400 may include, responsive to receiving the command to cut the NFT, verifying the sum of the selected weights of the constituent NFTs equals the weight value of the NFT, at 410. Responsive to verifying the sum of the selected weights of the constituent NFTs equals the weight value of the NFT, the process 400 may include burning the NFT and minting the constituent NFTs according to the selected weights of the constituent NFTs, at 412.

For instance, if a user selects a “POUND” NFT, which has a weight value of 1 (as detailed in Table 1), then the other 7 lesser weight options below the value of a POUND will be auto-calculated as a reference guide (2 HALF-POUND, 4 QUARTER-POUND, 16 OUNCE, etc.). If a HALF-POUND option is selected by the user (which has a weight value of 0.5), then 0.5 is deducted from the value of the POUND (value of 1), which leaves a balance of 0.5 remaining for the user to select additional NFTs to add to their cart. The HALF-POUND NFT is then added to the users cart to be minted once they have completed adding an amount of NFTs to their cart that is equal to that value of 1. The above process has now auto-rebalanced all of the remaining available cutting options (i.e., 1 HALF-POUND, 2 QUARTER-POUND, 8 OUNCE, etc.).

If the user then selects 2 QUARTER-POUND NFTs, they have now reached a balance of 0 (each QUARTER-POUND has a value of 0.25*2=0.5). The user's cart now has 3 new NFTs (1 HALF-POUND and 2 QUARTER-POUND) which add up to an equal value to their 1 POUND NFT that they are CUTTING.

Before confirming the CUT, a UI forces the user to select the NFT that they would like to use to pay their CUT FEE. For example, the CUT FEE can be a JOINT or a MUSIC NFT. If the user doesn't own a joint or music NFT, the user must choose 2 joints while choosing NFT weight. If a user has only the music NFT, then only the music NFT option will be enabled for paying a cut fee. If a user has only the joint NFT, then only the joint NFT option will be enabled for paying a cut fee. If a user has both music and joint NFT, the user can select either music or joint NFT. After an equal weight value and a cut fee option have been selected, the user must check the confirmation box and select ‘CUT NOW’, which launches a confirmation box ‘Are you sure you want to perform this action’.

On confirming, the wallet may ask for NFT approval to burn. The owner of the NFT must approve the permission for the cutting contract to burn their NFT. Once approved, the wallet will interact with the smart contract by invoking a contract function to cut NFT (Contract function—cut(NFTtokenId,metadata_of_new_nfts,user_wallet_address)). These values may be passed from the UI to the contract. These metadata may be fetched from a database using corresponding APIs.

The weight values may be verified inside the smart contract as part of a double validation. If the combination doesn't have a joint NFT and the user wallet doesn't hold a joint NFT, then the cutting process may be rejected. From the smart contract a balanceOf( ) function may be invoked to check whether the user hold music/joint NFTs. The contract function may verify that the weight of the new NFTs that have been selected to be minted are of equal value to the weight of the NFT that is being cut and burned. If these weight values do not match, the contract may be rejected (Contract function—verifyWeights(weightOfNftToBeBurned, weightToBeMinted)).

Once the weight values and ownership is verified, the cutting contract may burn the original NFT and mint the new constituent NFTs to the user's wallet in the selected weights. During the burning process, the burned NFT may be sent to a null address as part of a standard process. In some embodiments, once this action is completed it cannot be undone.

The cut fee may be transferred to the wallet configured inside the contract. This wallet may be predefined by an admin. New constituent NFTs may be minted. In this process a contract function for minting may be invoked (Contract function—mint(NFTmetadata_url,user_wallet_address,royalty recipient,royalty value)). The entire process of burning, cutting, minting and validating may be completely driven by a cutting smart contract.

In some embodiments, the user may send a request to consume one of the NFTs in a metaverse. Responsive to receiving the request from the user to consume the one of the constituent NFTs in the metaverse, the system may generate a 3D object in the metaverse based on the image, and allow the user to control an avatar of the user to consume the 3D object in the metaverse. In the cannabis example, the user may control the avatar to smoke a joint. Responsive to the user controlling the avatar of the user to consume the 3D object in the metaverse, the system may burn the corresponding NFT.

In some embodiments, the system may mint a seed NFT, and may allow the user to create a new NFT based on the seed NFT. For example, the system may mint a seed NFT for any constituent NFT minted above a predetermined weight. In some embodiments, when the user owns virtual land in a metaverse, the system may allow the user to create a new NFT based on the seed NFT. For example, the user may control an avatar to plant the seed NFT, which may then grow into a new virtual plant.

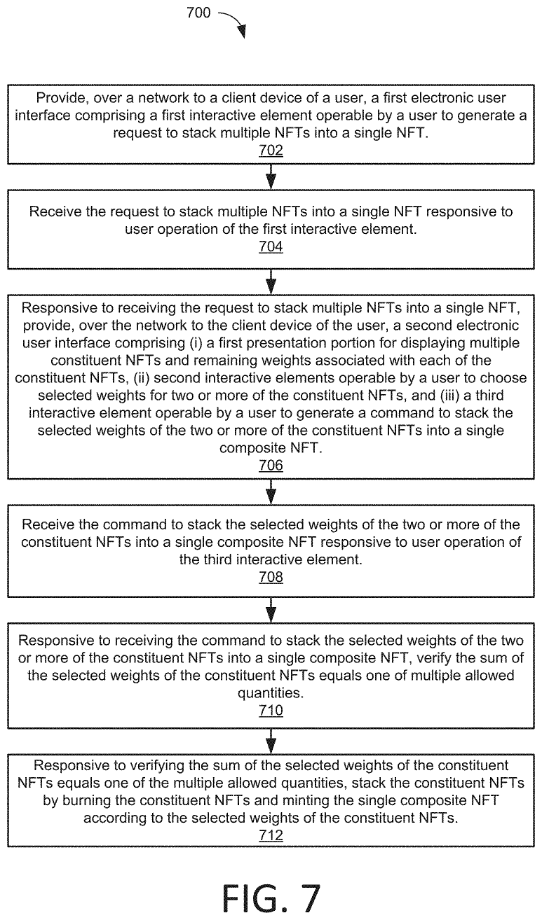

FIG. 7 is a flowchart illustrating a process 700 for NFT stacking and management according to some embodiments of the disclosed technologies. The elements of the process 700 are presented in one arrangement. However, it should be understood that one or more elements of the process may be performed in a different order, in parallel, omitted entirely, and the like. Furthermore, the process 700 may include other elements in addition to those presented. For example, the process 700 may include error-handling functions if exceptions occur, and the like. The process 700 may be executed, for example, by the NFT system 100 of FIGS. 1 and 2.

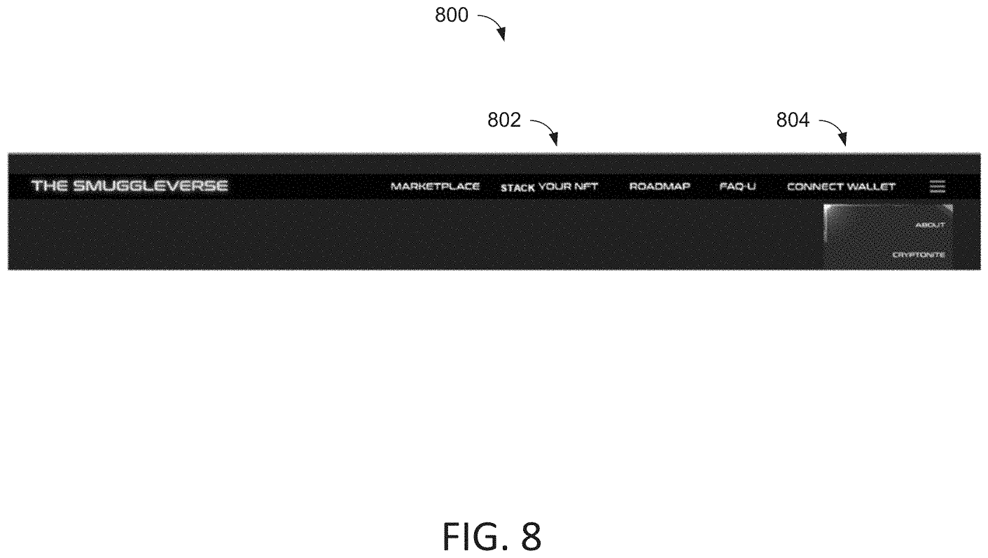

Referring again to FIG. 7, the process 700 may include providing, over a network to a client device of a user, a first electronic user interface comprising a first interactive element operable by a user to generate a request to stack multiple NFTs into a single NFT, at 702. FIG. 8 illustrates an example user interface 800 according to some embodiments of the disclosed technologies. The user interface 800 may include an interactive element, at 802, operable by a user to generate a request to stack multiple NFTs into a single NFT.

The system may determine whether a digital wallet of the user is connected to the system. Responsive to determining the digital wallet of the user is not connected to the system, the system may transmit, over the network to the client device, an electronic request to connect the digital wallet of the user to the system. The example user interface 800 may include an interactive element, at 804, operable by a user to connect a digital wallet to the system.

Referring again to FIG. 7, the process 700 may include receiving the request to stack multiple NFTs into a single NFT responsive to user operation of the first interactive element, at 704. From the UI a smart contract function may be invoked to verify that the user owns the selected NFTs (Contract function—balanceOf (NFT tokenId, user_connected_wallet_address)). If they are not owned by the user, the contract will return false. If they are owned by user, the contract will return true. Responsive to determining the user does not own the NFTs, the system may transmit, over the network to the client device, an electronic message denying the request to stack the NFTs.

From the UI, a smart contract function may be invoked to verify the selected NFTs' weight and value. From the UI, a smart contract function will be invoked to check whether the NFTs are on sale or not (Contract function—isOnSale (NFT tokenId)). If they are on sale, the contract will return a true value. If they is not on sale, the contract will return a false value. Responsive to determining the NFTs are on sale, the system may transmit, over the network to the client device, an electronic request to take the NFTs off sale.

If the NFTs are not on sale, another smart contract function may be invoked from UI to check whether the NFTs are on auction or not (Contract function—isOnAuction(NFT tokenId)). If they are on auction, the contract will return a true value. If they are not in auction, the contract will return a false value. Responsive to determining the NFTs are on auction, the system may transmit, over the network to the client device, an electronic request to take the NFTs off auction.

The process 700 may include, responsive to receiving the request to stack multiple NFTs into a single NFT, providing, over the network to the client device of the user, a second electronic user interface comprising (i) a first presentation portion for displaying multiple constituent NFTs and remaining weights associated with each of the constituent NFTs, (ii) second interactive elements operable by a user to choose selected weights for two or more of the constituent NFTs, and (iii) a third interactive element operable by a user to generate a command to stack the selected weights of the two or more of the constituent NFTs into a single composite NFT, at 706.

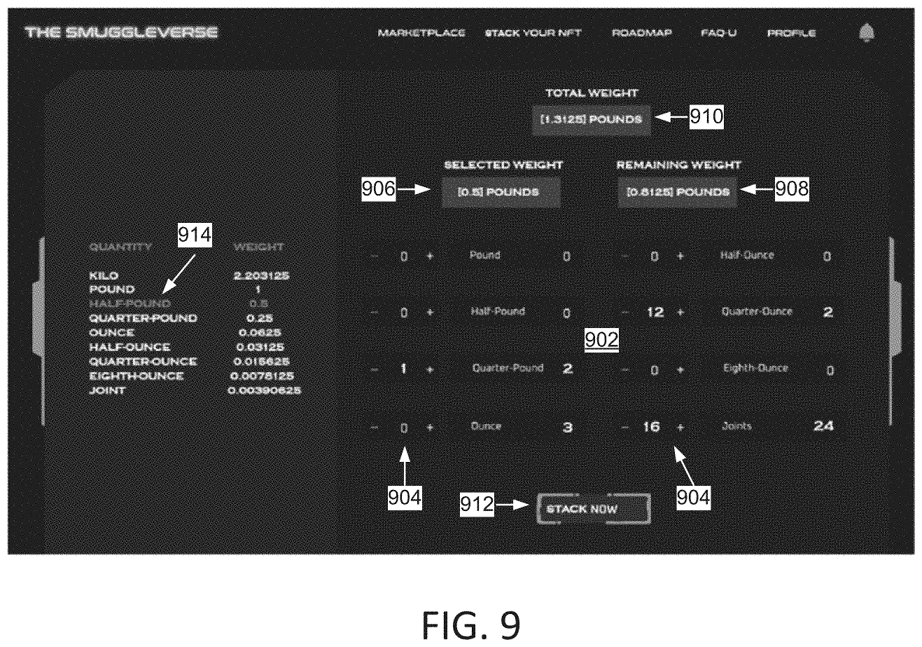

FIG. 9 illustrates an example user interface 900 according to some embodiments of the disclosed technologies. Referring to FIG. 9, the user interface 900 may include a presentation portion. The presentation portion may display the NFTs held by the user, at 902. In the example of FIG. 9, the presentation portion displays the weight value of each quantity held by the user. In the example of FIG. 9, the user holds 3 quarter-pounds, 3 ounces, 14 quarter-ounces, and 40 joints.

The user interface 900 may also include interactive elements. For example, the interactive elements may allow the user to select constituent NFTs to be stacked, by quantity and weight value, at 904. In the example of FIG. 9, the user has selected 1 quarter-pound, 12 quarter-ounces, and 16 joints. The presentation portion may display the sum of the selected constituent NFTs (“SELECTED WEIGHT”), at 906, the sum of the non-selected constituent NFTs (“REMAINING WEIGHT”), at 908, and the sum of all of the NFTs held by the user (“TOTAL WEIGHT”), at 910.

The user interface 800 may include an interactive element, at 912, operable by a user to generate a command to stack the selected constituent NFTs into a single composite NFT. Referring again to FIG. 7, the process 700 may include receiving the command to stack the selected weights of the two or more of the constituent NFTs into a single composite NFT responsive to user operation of the third interactive element 912, at 708.

The process 700 may include, responsive to receiving the command to stack the selected weights of the two or more of the constituent NFTs into a single composite NFT, verifying the sum of the selected weights of the constituent NFTs equals one of multiple allowed quantities, at 710. The allowed quantities may be, for example, as listed in Table 1. Referring again to FIG. 8, responsive to a successful verification, the verified quantity may be highlighted in the user interface 800, at 914.

Responsive to verifying the sum of the selected weights of the constituent NFTs equals one of the multiple allowed quantities, the process 700 may include stacking the constituent NFTs by burning the constituent NFTs and minting the single composite NFT according to the selected weights of the constituent NFTs, at 712. In the example of FIG. 9, the system will burn 1 quarter-pound, 12 quarter-ounces, and 16 joints, and mint one half-pound.

Before confirming the STACK, a UI forces the user to select the NFT that they would like to use to pay their STACK FEE. For example, the STACK FEE can be a JOINT or a MUSIC NFT. If a user has only the music NFT, then only the music NFT option will be enabled for paying a STACK fee. If a user has only the joint NFT, then only the joint NFT option will be enabled for paying a STACK fee. If a user has both music and joint NFT, the user can select either music or joint NFT. After an equal weight value and a STACK fee option have been selected, the user must check a confirmation box and select ‘STACK NOW’, which launches a confirmation box ‘Are you sure you want to perform this action’.

On confirming, the wallet may ask for NFT approval to burn. The owner of the NFT must approve the permission for the stacking contract to burn their NFTs. Once approved, the wallet will interact with the smart contract by invoking a contract function to stack NFT. These values may be passed from the UI to the contract. These metadata may be fetched from a database using corresponding APIs.

The weight values may be verified inside the smart contract as part of a double validation. If the user wallet doesn't hold a joint or music NFT to cover the CUT FEE, then the stacking process may be rejected. From the smart contract a balanceOf( ) function may be invoked to check whether the user hold music/joint NFTs. The contract function may verify that the weight of the new NFT to be minted is of equal value to the weight of the NFTs being stacked and burned. If these weight values do not match, the contract may be rejected (Contract function—verifyWeights(weightOfNftToBeBurned,weightToBeMinted)).

Once the weight value and ownership is verified, the stacking contract may burn the original constituent NFTs and mint the new composite NFT to the user's wallet in the selected weight. During the burning process, the burned NFTs may be sent to a null address as part of a standard process. In some embodiments, once this action is completed it cannot be undone.

The stacking fee may be transferred to the wallet configured inside the contract. This wallet may be predefined by an admin. A single new composite NFT may be minted. In this process a contract function for minting may be invoked (Contract function—mint(NFTmetadata_url,user_wallet_address,royalty recipient,royalty value)). The entire process of burning, stacking, minting and validating may be completely driven by a stacking smart contract.

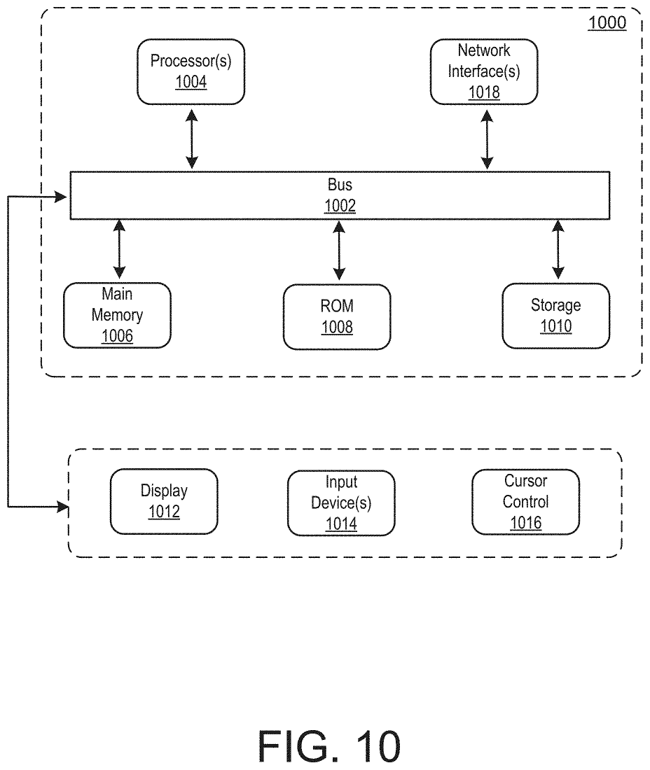

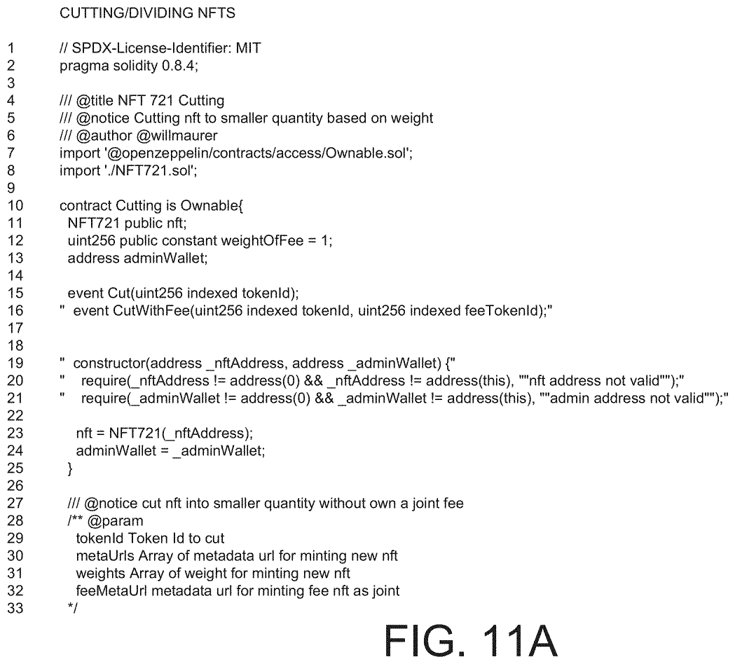

FIG. 10 depicts a block diagram of an example computer system 1000 in which embodiments described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some embodiments, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a communication interface 1018 coupled to bus 1002. Network interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or a WAN component to communicate with a WAN). Wireless links may also be implemented. In any such implementation, network interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1018, which carry the digital data to and from computer system 1000, are example forms of transmission media.

The computer system 1000 can send messages and receive data, including program code, through the network(s), network link and communication interface 1018. In the Internet example, a server might transmit a requested code for an application program through the Internet, the ISP, the local network and the communication interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

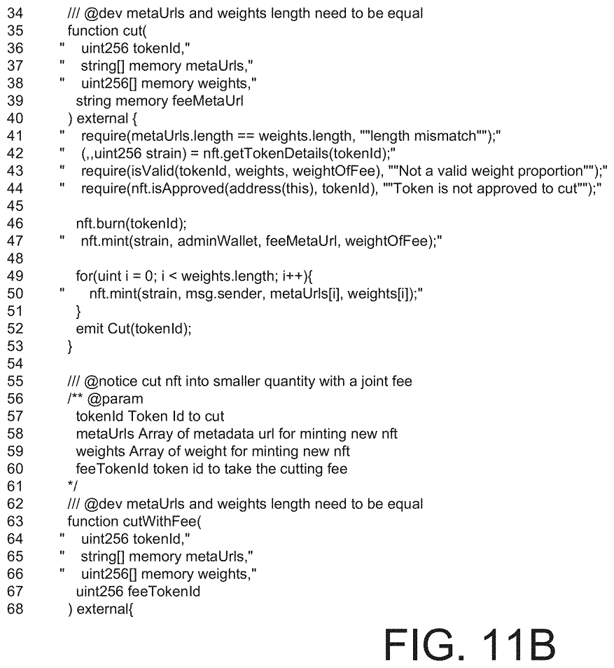

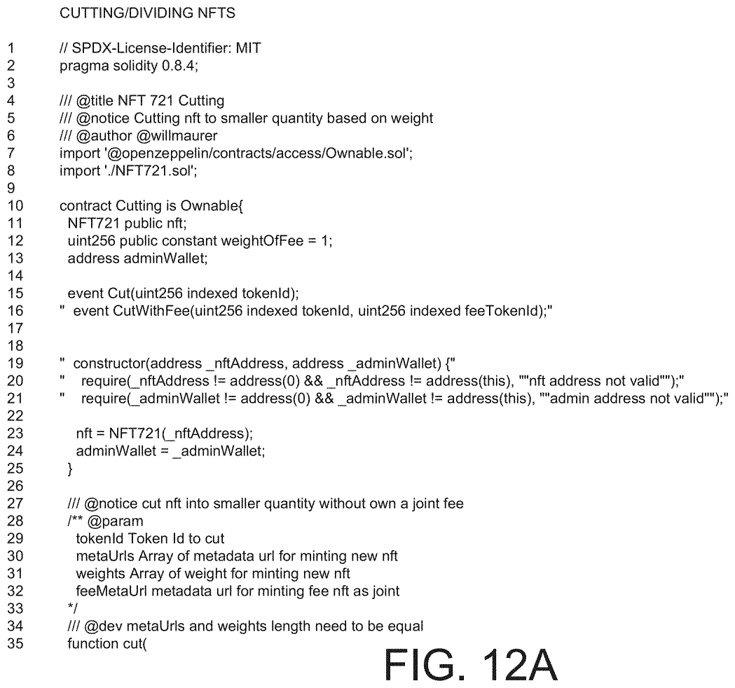

FIGS. 11A,B illustrate code for a non-limiting example of one way to implement a system for cutting NFTs according to some embodiments of the disclosed technology.

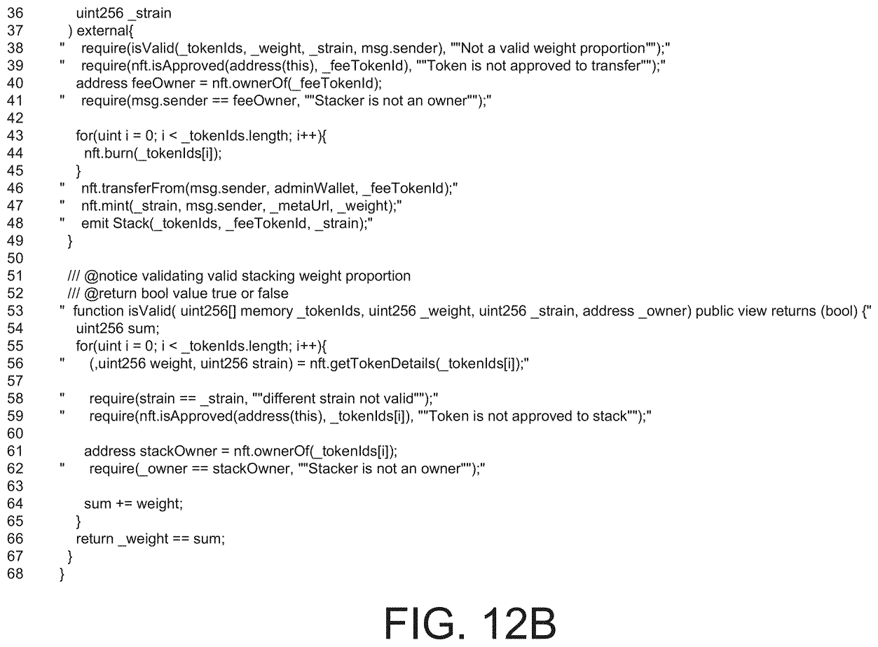

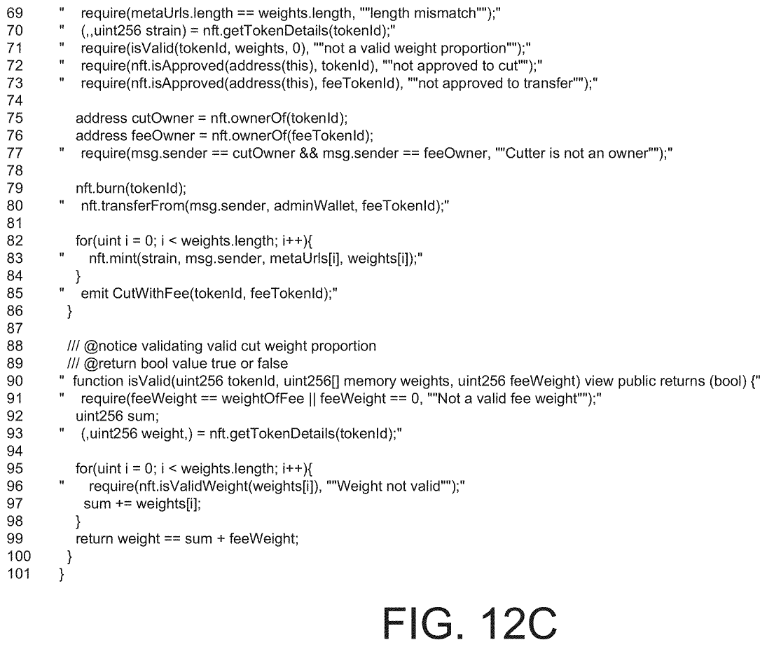

FIGS. 12A,B,C illustrate code for a non-limiting example of one way to implement a system for stacking NFTs according to some embodiments of the disclosed technology.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for managing the conversion of non-fungible tokens (NFTs) into constituent NFTs, the system comprising:
a hardware processor; and
a non-transitory machine-readable storage medium encoded with instructions executable by the hardware processor to perform operations comprising:
providing, over a network to a client device of a user, a first electronic user interface comprising (i) a first presentation portion for displaying an image associated with an NFT and a value associated with the NFT and (ii) a first interactive element operable by a user to generate a request to cut the NFT into multiple constituent NFTs;
receiving the request to cut the NFT responsive to user operation of the first interactive element;
responsive to receiving the request to cut the NFT, providing, over the network to the client device, a second electronic user interface comprising (i) at least one second interactive element operable by the user to select a respective value from a set of predetermined values for each of the constituent NFTs and (ii) a third interactive element operable by the user to generate a command to cut the NFT according to the selected values for each of the constituent NFTs;
receiving the command to cut the NFT responsive to user operation of the third interactive element;
responsive to receiving the command to cut the NFT, verifying the sum of the selected values of the constituent NFTs equals the value of the NFT; and
responsive to verifying the sum of the selected values of the constituent NFTs equals the value of the NFT, burning the NFT and minting the constituent NFTs according to the selected values of the constituent NFTs.

2. The system of claim 1, wherein, responsive to receiving the request to cut the NFT, and prior to providing the second electronic user interface, the operations further comprise:
determining whether a digital wallet of the user is connected to the system; and
responsive to determining the digital wallet of the user is not connected to the system, transmitting, over the network to the client device, an electronic request to connect the digital wallet of the user to the system.

3. The system of claim 1, wherein, responsive to receiving the request to cut the NFT, and prior to providing the second electronic user interface, the operations further comprise at least one of:
determining whether the user owns the NFT, and responsive to determining the user does not own the NFT, transmitting, over the network to the client device, an electronic message denying the request to cut the NFT;
determining whether the NFT is on sale, and responsive to determining the NFT is on sale, transmitting, over the network to the client device, an electronic request to take the NFT off sale;
determining whether the NFT is on auction, and responsive to determining the NFT is on auction, transmitting, over the network to the client device, an electronic request to take the NFT off auction; or
verifying a value of the NFT.

4. The system of claim 1, wherein the operations further comprise:
prior to burning the NFT and minting the constituent NFTs, identifying a further NFT to be used to pay a cutting fee.

5. The system of claim 1, wherein the operations further comprise:
receiving, over the network from the client device, a request from the user to consume one of the constituent NFTs in a metaverse;
responsive to receiving the request from the user to consume the one of the constituent NFTs in the metaverse, generating a 3D object in the metaverse based on the image, and allowing the user to control an avatar of the user to consume the 3D object in the metaverse; and
responsive to the user controlling the avatar of the user to consume the 3D object in the metaverse, burning the one of the constituent NFTs.

6. The system of claim 1, wherein minting the constituent NFTs comprises:
minting a seed NFT for any constituent NFT minted above a predetermined value; and
when the user owns virtual land in a metaverse, allowing the user to create a new NFT based on the seed NFT.

7. A system for managing the combination of non-fungible tokens (NFTs), the system comprising:
a hardware processor; and
a non-transitory machine-readable storage medium encoded with instructions executable by the hardware processor to perform operations comprising:
providing, over a network to a client device of a user, a first electronic user interface comprising a first interactive element operable by a user to generate a request to stack multiple NFTs into a single NFT;
receiving the request to stack multiple NFTs into a single NFT responsive to user operation of the first interactive element;
responsive to receiving the request to stack multiple NFTs into a single NFT, providing, over the network to the client device of the user, a second electronic user interface comprising (i) a first presentation portion for displaying multiple constituent NFTs and remaining values associated with each of the constituent NFTs, (ii) second interactive elements operable by a user to choose selected values for two or more of the constituent NFTs, and (iii) a third interactive element operable by a user to generate a command to stack the selected values of the two or more of the constituent NFTs into a single composite NFT;
receiving the command to stack the selected values of the two or more of the constituent NFTs into a single composite NFT responsive to user operation of the third interactive element;
responsive to receiving the command to stack the selected values of the two or more of the constituent NFTs into a single composite NFT, verifying the sum of the selected values of the constituent NFTs equals an allowed value from a set of predetermined values; and
responsive to verifying the sum of the selected values of the constituent NFTs equals one of the allowed values, stacking the constituent NFTs by burning the constituent NFTs and minting the single composite NFT according to the selected value of the constituent NFTs.

8. The system of claim 7, wherein, responsive to receiving the command to stack the selected values of the two or more of the constituent NFTs into a single composite NFT, and prior to stacking the constituent NFTs, the operations further comprise:
determining whether a digital wallet of the user is connected to the system; and
responsive to determining the digital wallet of the user is not connected to the system, transmitting, over the network to the client device, an electronic request to connect the digital wallet of the user to the system.

9. The system of claim 7, wherein, responsive to receiving the command to stack the selected values of the two or more of the constituent NFTs into a single composite NFT, and prior to stacking the constituent NFTs, the operations further comprise at least one of:
determining whether the user owns the constituent NFTs, and responsive to determining the user does not own the constituent NFTs, transmitting, over the network to the client device, an electronic message denying the command to stack the selected values of the two or more of the constituent NFTs into a single composite NFT;
determining whether the constituent NFTs are on sale, and responsive to determining the constituent NFTs are on sale, transmitting, over the network to the client device, an electronic request to take the constituent NFTs off sale;
determining whether the constituent NFTs are on auction, and responsive to determining the constituent NFTs are on auction, transmitting, over the network to the client device, an electronic request to take the constituent NFTs off auction; or
verifying values of the constituent NFTs.

10. The system of claim 7, wherein the operations further comprise:
prior to stacking the constituent NFTs, identifying a further NFT to be used to pay a stacking fee.

11. The system of claim 7, wherein the operations further comprise:
receiving, over the network from the client device, a request from the user to consume the single composite NFT in a metaverse;
responsive to receiving the request from the user to consume the single composite NFT in the metaverse, generating a 3D object in the metaverse based on the single composite NFT, and allowing the user to control an avatar of the user to consume the 3D object in the metaverse; and
responsive to the user controlling the avatar of the user to consume the 3D object in the metaverse, burning the single composite NFT.

12. A non-transitory machine-readable storage medium encoded with instructions executable by a hardware processor to perform operations comprising:
providing, over a network to a client device of a user, a first electronic user interface comprising (i) a first presentation portion for displaying an image associated with a non-fungible token (NFT) and a value associated with the NFT and (ii) a first interactive element operable by a user to generate a request to cut the NFT into multiple constituent NFTs;
receiving the request to cut the NFT responsive to user operation of the first interactive element;
responsive to receiving the request to cut the NFT, providing, over the network to the client device, a second electronic user interface comprising (i) at least one second interactive element operable by the user to select a respective value from a set of predetermined values for each of the constituent NFTs and (ii) a third interactive element operable by the user to generate a command to cut the NFT according to the selected values for each of the constituent NFTs;
receiving the command to cut the NFT responsive to user operation of the third interactive element;
responsive to receiving the command to cut the NFT, verifying the sum of the selected values of the constituent NFTs equals the value of the NFT; and
responsive to verifying the sum of the selected values of the constituent NFTs equals the value of the NFT, burning the NFT and minting the constituent NFTs according to the selected values of the constituent NFTs.

13. The non-transitory machine-readable storage medium of claim 12, wherein, responsive to receiving the request to cut the NFT, and prior to providing the second electronic user interface, the operations further comprise:
determining whether a digital wallet of the user is connected; and
responsive to determining the digital wallet of the user is not connected, transmitting, over the network to the client device, an electronic request to connect the digital wallet of the user.

14. The non-transitory machine-readable storage medium of claim 12, wherein, responsive to receiving the request to cut the NFT, and prior to providing the second electronic user interface, the operations further comprise at least one of:
determining whether the user owns the NFT, and responsive to determining the user does not own the NFT, transmitting, over the network to the client device, an electronic message denying the request to cut the NFT;
determining whether the NFT is on sale, and responsive to determining the NFT is on sale, transmitting, over the network to the client device, an electronic request to take the NFT off sale;
determining whether the NFT is on auction, and responsive to determining the NFT is on auction, transmitting, over the network to the client device, an electronic request to take the NFT off auction; or
verifying a value of the NFT.

15. The non-transitory machine-readable storage medium of claim 12, wherein the operations further comprise:
prior to burning the NFT and minting the constituent NFTs, identifying a further NFT to be used to pay a cutting fee.

16. The non-transitory machine-readable storage medium of claim 12, wherein the operations further comprise:
receiving, over the network from the client device, a request from the user to consume one of the constituent NFTs in a metaverse;
responsive to receiving the request from the user to consume the one of the constituent NFTs in the metaverse, generating a 3D object in the metaverse based on the image, and allowing the user to control an avatar of the user to consume the 3D object in the metaverse; and
responsive to the user controlling the avatar of the user to consume the 3D object in the metaverse, burning the one of the constituent NFTs.

17. The non-transitory machine-readable storage medium of claim 12, wherein minting the constituent NFTs comprises:
minting a seed NFT for any constituent NFT minted above a predetermined value; and
when the user owns virtual land in a metaverse, allowing the user to create a new NFT based on the seed NFT.

18. A non-transitory machine-readable storage medium encoded with instructions executable by a hardware processor to perform operations comprising:
providing, over a network to a client device of a user, a first electronic user interface comprising a first interactive element operable by a user to generate a request to stack multiple non-fungible tokens (NFTs) into a single NFT;
receiving the request to stack multiple NFTs into a single NFT responsive to user operation of the first interactive element;
responsive to receiving the request to stack multiple NFTs into a single NFT, providing, over the network to the client device of the user, a second electronic user interface comprising (i) a first presentation portion for displaying multiple constituent NFTs and remaining values associated with each of the constituent NFTs, (ii) second interactive elements operable by a user to choose selected values for two or more of the constituent NFTs, and (iii) a third interactive element operable by a user to generate a command to stack the selected values of the two or more of the constituent NFTs into a single composite NFT;
receiving the command to stack the selected values of the two or more of the constituent NFTs into a single composite NFT responsive to user operation of the third interactive element;
responsive to receiving the command to stack the selected values of the two or more of the constituent NFTs into a single composite NFT, verifying the sum of the selected values of the constituent NFTs equals an allowed value from a set of predetermined values; and
responsive to verifying the sum of the selected values of the constituent NFTs equals one of the allowed values, stacking the constituent NFTs by burning the constituent NFTs and minting the single composite NFT according to the selected value of the constituent NFTs.

19. The non-transitory machine-readable storage medium of claim 18, wherein, responsive to receiving the command to stack the selected values of the two or more of the constituent NFTs into a single composite NFT, and prior to stacking the constituent NFTs, the operations further comprise:
determining whether a digital wallet of the user is connected; and
responsive to determining the digital wallet of the user is not connected, transmitting, over the network to the client device, an electronic request to connect the digital wallet of the user.

20. The non-transitory machine-readable storage medium of claim 18, wherein, responsive to receiving the command to stack the selected values of the two or more of the constituent non-fungible tokens (NFTs) into a single composite NFT, and prior to stacking the constituent NFTs, the operations further comprise at least one of:
determining whether the user owns the constituent NFTs, and responsive to determining the user does not own the constituent NFTs, transmitting, over the network to the client device, an electronic message denying the command to stack the selected values of the two or more of the constituent NFTs into a single composite NFT;
determining whether the constituent NFTs are on sale, and responsive to determining the constituent NFTs are on sale, transmitting, over the network to the client device, an electronic request to take the constituent NFTs off sale;
determining whether the constituent NFTs are on auction, and responsive to determining the constituent NFTs are on auction, transmitting, over the network to the client device, an electronic request to take the constituent NFTs off auction; or
verifying values of the constituent NFTs.

21. The non-transitory machine-readable storage medium of claim 18, wherein the operations further comprise:
prior to stacking the constituent NFTs, identifying a further NFT to be used to pay a stacking fee.

22. The non-transitory machine-readable storage medium of claim 18, wherein the operations further comprise:
receiving, over the network from the client device, a request from the user to consume the single composite NFT in a metaverse;
responsive to receiving the request from the user to consume the single composite NFT in the metaverse, generating a 3D object in the metaverse based on the single composite NFT, and allowing the user to control an avatar of the user to consume the 3D object in the metaverse; and
responsive to the user controlling the avatar of the user to consume the 3D object in the metaverse, burning the single composite NFT.
